(19) United States
(12) Patent Application Publication
(10) Pub. No.: US 2026/0357011 A1
(43) Pub. Date: Nov. 12, 2026

(54) SULFUR-TRIAZINE POLYMER AND LITHIUM-SULFUR BATTERY THAT CONTAINS SAME AS POSITIVE ELECTRODE AND THUS CAN BE USED IN LEAN ELECTROLYTE

(71) Applicant: INDUSTRY-ACADEMIC COOPERATION FOUNDATION GYEONGSANG NATIONAL UNIVERSITY, Jinju-si, Gyeongsangnam-do (KR)

(72) Inventors: Hyun Young JUNG, Jinju-si, Gyeongsangnam-do (KR); Senthil CHENRAYAN, Jinju-si, Gyeongsangnam-do (KR)

(73) Assignee: INDUSTRY-ACADEMIC COOPERATION FOUNDATION GYEONGSANG NATIONAL UNIVERSITY, Jinju-si, Gyeongsangnam-do (KR)

(21) Appl. No.: 19/118,355

(22) PCT Filed: Sep. 19, 2023
(86) PCT No.: PCT/KR2023/014131

§ 371 Date: Apr. 4, 2025

(30) Foreign Application Priority Data
Oct. 5, 2022 (KR) 10-2022-0127009

(51) Int. Cl. C08G 73/06; C08G 75/30; H01M 4/02; H01M 4/60; H01M 10/052; H01M 50/105

(52) U.S. Cl. CPC C08G 73/0683; C08G 75/30; H01M 4/602; H01M 10/052; H01M 50/105; H01M 2004/028

(57) ABSTRACT

A sulfurized-triazine polymer includes a triazine polymer and sulfur. The sulfur is covalently grafted to the triazine polymer. The sulfurized-triazine polymer has at least one structure selected from the group consisting of Formulas 2 to 7. The sulfur is covalently bonded to a triazine polymer having a graphitic carbon nitride structure represented by Formula 1.

### CROSS-REFERENCE TO PRIOR APPLICATIONS

This application is a National Stage Patent Application of PCT International Application No. PCT/KR2023/014131 (filed on Sep. 19, 2023), which claims priority to Korean Patent Application No. 10-2022-0127009 (filed on Oct. 5, 2022), which are all hereby incorporated by reference in their entirety.

### BACKGROUND

The present invention relates to a sulfurized-triazine polymer and a lithium-sulfur battery that comprises the same as a cathode and thus is usable under lean electrolyte conditions, and more particularly, to a sulfurized-triazine polymer produced by covalently grafting sulfur to triazine and a lithium-sulfur battery that comprises the same as a cathode and thus exhibits high performance even under lean electrolyte conditions.

Lithium-sulfur (Li—S) batteries are attracting much attention as next-generation high-performance secondary batteries that overcome the limitations of lithium-ion batteries due to their high theoretical energy density of 2,567 Wh/kg and environmental friendliness. However, they have many limitations in achieving a practical specific energy of 500 Wh/kg, due to the “dissolution-precipitation” reaction in the currently used ether-based electrolyte. The main reason for such limitations is that the active material sulfur in the cathode gets lost in the form of polysulfides.

Two major solutions have been used to overcome this problem. One is to increase the activity of sulfur by introducing appropriate host materials such as nanocarbons and metal oxides. Another solution is a method of improving the cycle characteristics of the battery by using a large amount of electrolyte. However, this method has a problem in that the energy density of the lithium-sulfur battery is limited to 130 Wh/kg when the electrolyte/electrode ratio is 30 μL/mg or higher. In addition, where a host material is introduced to the sulfur electrode, serious problems occur in the cycle performance of the battery due to kinetic issues under lean electrolyte conditions.

Due to these problems, there is an increasing need for the development of a novel cathode, which can exhibit high performance even under lean electrolyte conditions, through an integrated solution that is able to disperse insulative sulfur using a carbon host or support matrix at a molecular level, improve wettability and pore characteristics of the cathode, and at the same time, immobilize polysulfides strongly.

### SUMMARY

The present invention has been made in order to solve the above-described problems, and an object of the present invention is to provide a sulfurized-triazine polymer that may be comprised as a cathode for a battery and immobilize polysulfides.

Another object of the present invention is to provide a lithium-sulfur battery that comprises a sulfurized-triazine polymer as a cathode and thus exhibits high performance even under lean electrolyte conditions.

The technical problems to be solved by the present invention are not limited to the technical problems mentioned above, and other technical problems not mentioned may be clearly understood by those of ordinary skill in the art from the description of the present invention.

To achieve the above objects, the present invention provides a sulfurized-triazine polymer and a lithium-sulfur battery usable under lean electrolyte conditions comprising the same in a cathode.

The present invention provides a sulfurized-triazine polymer comprising: a triazine polymer and sulfur, wherein the sulfur is covalently grafted to the triazine polymer.

In the present invention, the sulfurized-triazine polymer may have at least one structure selected from the group consisting of Formulas 2 to 7 below, wherein sulfur is covalently bonded to a triazine polymer having a graphitic carbon nitride structure represented by Formula 1 below:

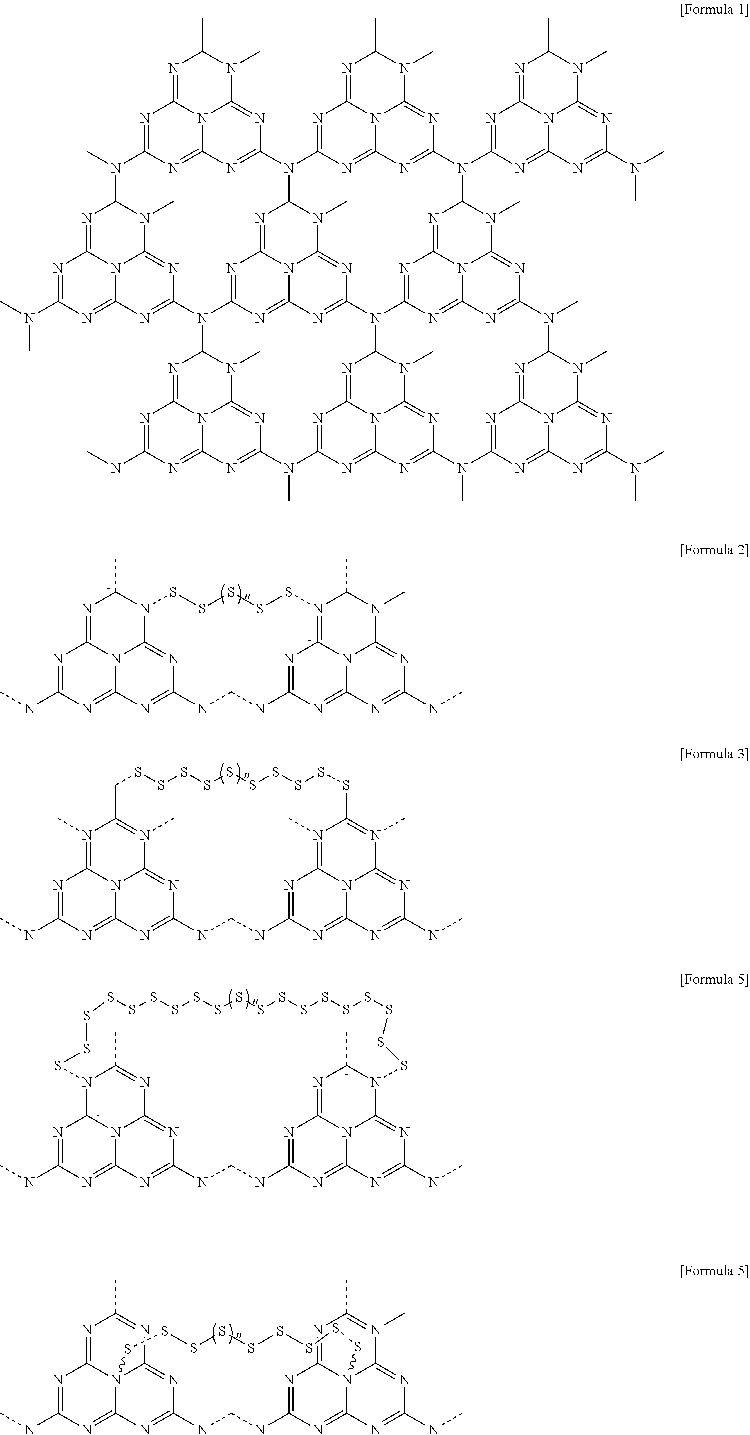

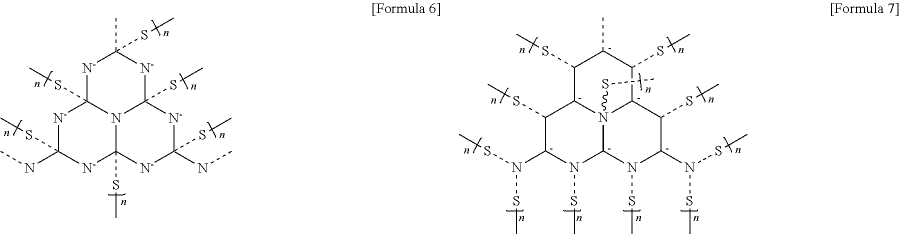

The present invention provides a lithium-sulfur battery usable under lean electrolyte conditions, comprising, as a cathode, a sulfurized-triazine polymer produced as described above.

In the present invention, the lithium-sulfur battery may exhibit battery performance under electrolyte conditions with a lean electrolyte/electrode ratio of 4 to 10 μL/mg.

In the present invention, Li₂S₄ generated during charge and discharge of the lithium-sulfur battery may be subjected to bulk-immobilization by interaction with at least one selected from the group consisting of pyridinic-N and pyrrolic-N.

In the present invention, the lithium-sulfur battery may exhibit an electric capacity of 500 to 650 mAh/g at the 150^{th} to 200^{th} cycles.

In the present invention, the lithium-sulfur battery may exhibit a Coulombic efficiency of 85 to 98% at an electrolyte/electrode ratio of 4 to 10 μL/mg when a sulfur loading amount of 3 to 7 mg/cm² is applied.

In the present invention, the lithium-sulfur battery may exhibit a capacity of 500 to 650 mAh/g at an electrolyte/electrode ratio of 4 to 10 μL/mg when a sulfur loading amount of 3 to 7 mg/cm² is applied.

In the present invention, the lithium-sulfur battery may be used as a pouch cell and it exhibits an energy density of 300 to 400 Wh/kg when used as the pouch cell.

In the present invention, the lithium-sulfur battery may be used as a flexible cell.

The present specification will be described in more detail below.

According to the above technical solution, the present invention may provide a sulfurized-triazine polymer that may be used in a cathode for a battery and immobilize polysulfide.

In addition, the present invention may provide a lithium-sulfur battery that comprises a sulfurized-triazine polymer in a cathode and thus exhibits high performance even under lean electrolyte conditions.

The effects of the present invention are not limited to the effects mentioned above, and other effects not mentioned will be clearly understood by those skilled in the art from the description of the claims.

### BRIEF DESCRIPTION OF THE DRAWINGS

FIG. 1 schematically shows a lithium-sulfur battery comprising a cathode comprising a sulfurized-triazine polymer under lean electrolyte conditions according to the present invention (a) and the preparation and structure of a sulfurized-triazine polymer (b).

FIG. 2 schematically shows a process in which Li₂S₄ is subjected to bulk-immobilization by interaction with at least one selected from the group consisting of pyridinic-N and pyrrolic-N during charge/discharge of a sulfurized-triazine electrode.

FIG. 3 schematically shows the polysulfide reaction pathway of a sulfurized-triazine cathode undergoing bulk-immobilization compared to a sulfurized-carbon electrode undergoing surface-immobilization of polysulfide, and bulk-immobilization against the surface-immobilization occurring inside a lean Li—S cell.

FIG. 4 shows the results obtained according to Experimental Example 1. (a) FT-IR spectra of the STP electrode and the S/C electrode, and (b) Raman spectra showing covalent bonds.

FIGS. 5a to 5j show the results obtained according to Experimental Example 1. FIG. 5a illustrates a cyclic voltammogram shown for the 5^{th} cycle, obtained at a scan rate of 0.1 mV/s in a voltage range of 1.7 to 2.8 V. FIG. 5b illustrates a graph showing redox peak currents derived at a respective reduction (A1 and A2 in FIG. 5a) and oxidation (C1 in FIG. 5a) peaks currents. FIG. 5c illustrates a graph showing reduction and oxidation current as a function of various /S ratios. FIG. 5d illustrates a galvanostatic discharge/charge profile at various E/S ratios (2, 4, 6, and 8 μL/mg) at current rates of C/2 and 1C. FIG. 5e illustrates a capacity retention plot obtained for various E/S ratios at a current rate of C/2. FIG. 5f illustrates a capacity retention plot obtained for various E/S ratios at a current rate of 1C. FIG. 5g illustrates a graph showing the sulfur utilization at the capacity obtained at high plateau (QH) and low plateau (QL) at various E/S ratios in Li—S cells at current rates of C/2 and 1C. FIG. 5h illustrates a graph showing the ratio of sulfur utilized at the high plateau and low plateau against a total sulfur (ideal value 3.00%) based on practical capacity obtained at E/S ratio. FIG. 5i illustrates a bar chart depicting the voltage polarization depending on each E/S ratio at current rates of C/2 and 1C derived from FIG. 5f. FIG. 5j illustrates and electrochemical impedance spectroscopy (EIS) portrayed as Nyquist plots at E/S ratios of 4, 6, 8, and 15 μL/mg.

FIG. 6 shows the results obtained according to Experimental Example 3. (a) Ideal structure of carbon nitride. (b) Density-functional theory analysis of pyridinic-N, pyrrolic-N, and graphitic-N interaction with Li₂S₄ and Li₂S polysulfides.

FIGS. 7a to 7j show the results obtained according to Experimental Example 4. FIG. 7a illustrates a schematic illustration of a Li—S pouch cell composed of a thin Li anode, a separator wetted as per E/S ratio, and an STP cathode. FIG. 7b illustrates a digital photograph showing a lean Li—S pouch cell exhibiting a stable open-circuit voltage of 2.83 V. FIG. 7c illustrates a galvanostatic discharge/charge profile of a lean Li—S pouch cell, measured at C/5 current rate. FIG. 7d illustrates a capacity retention graph of a lean-electrolyte Li—S pouch cell, measured at C/5 rate. FIG. 7e illustrates a digital photograph showing the operation of dozens of light-emitting diodes powered by lean Li—S pouch cells. FIG. 7f illustrates a mass ratios of various cell components as a function of different E/S ratios and respective practical capacities. FIG. 7g illustrate E/S ratios and cell's mass and energy density. FIG. 7h illustrates a cyclic voltammogram shown for 5^{th} and 10^{th} cycles recorded at a scan rate of 0.1 mV/s. FIG. 7i illustrates an estimation of energy density depending on E/S ratio and sulfur content and measured energy density of a lean Li—S cell. FIG. 7j illustrates a comparison of energy density values at lean (≤8 μL/mg) and flooded (>8 μL/mg) electrolyte conditions.

### DETAILED DESCRIPTION

The terms used in the present specification are currently widely used general terms selected in consideration of their functions in the present invention, but they may change depending on the intents of those skilled in the art, precedents, or the advents of new technology. Additionally, in certain cases, there may be terms arbitrarily selected by the applicant, and in this case, their meanings will be described in a corresponding description part of the present invention. Accordingly, terms used in the present invention should be defined based on the meaning of the term and the entire contents of the present invention, rather than the simple term name.

Unless otherwise defined, all terms used herein, including technical or scientific terms, have the same meanings as understood by those skilled in the art to which the present disclosure pertains. Terms such as those used in general and defined in dictionaries should be interpreted as having meanings identical to those specified in the context of related technology. Unless definitely defined in the present application, the terms should not be interpreted as having ideal or excessively formative meanings.

A numerical range includes numerical values defined in the range. Every maximum numerical limitation given throughout the present specification includes every lower numerical limitation, as if such lower numerical limitations were expressly written herein. Every minimum numerical limitation given throughout the present specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

The advantages and features of the present invention, and the way of attaining them, will become apparent with reference to the embodiments below described in detail. However, the present invention is not limited to the embodiments disclosed below and may be embodied in a variety of different forms. Rather, these embodiments are provided so that this disclosure will be thorough and complete, and will fully convey the scope of the present invention to those skilled in the art. The present invention will be defined only by the scope of the claims.

### Sulfurized-Triazine Polymer

The present invention relates to a sulfurized-triazine polymer comprising: a triazine polymer and sulfur, wherein the sulfur is covalently grafted to the triazine polymer.

The triazine polymer affords covalent sulfur grafting through C—S bonds to maintain a sulfur content of 60% or higher, and the grafted sulfur and sulfur rings (S) are highly reactive with Li ions, so that the reaction therebetween may easily occur.

The sulfurized-triazine polymer may have at least one structure selected from the group consisting of Formulas 2 to 7 below, wherein sulfur is covalently bonded to a triazine polymer having a graphitic carbon nitride structure represented by Formula 1 below:

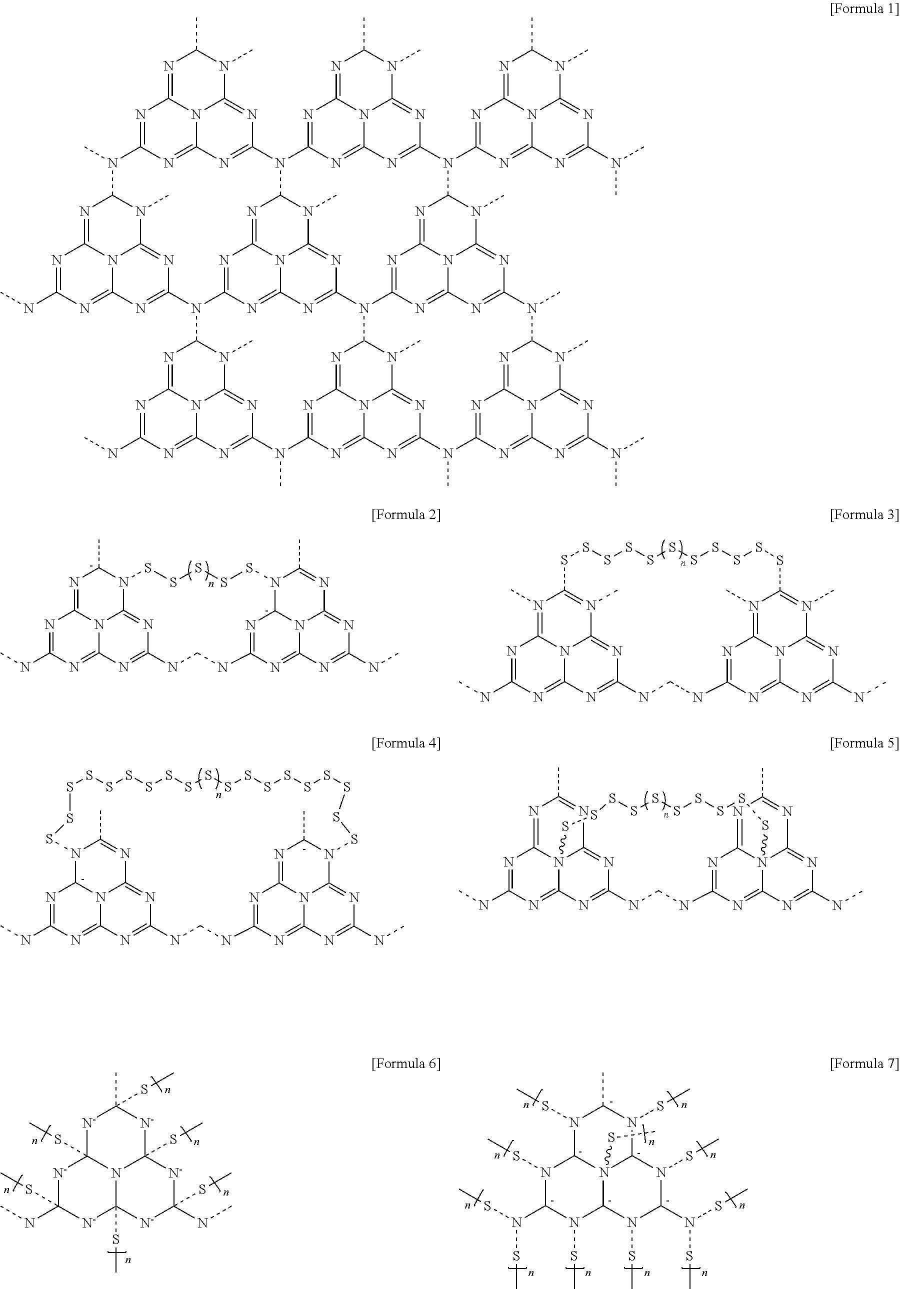

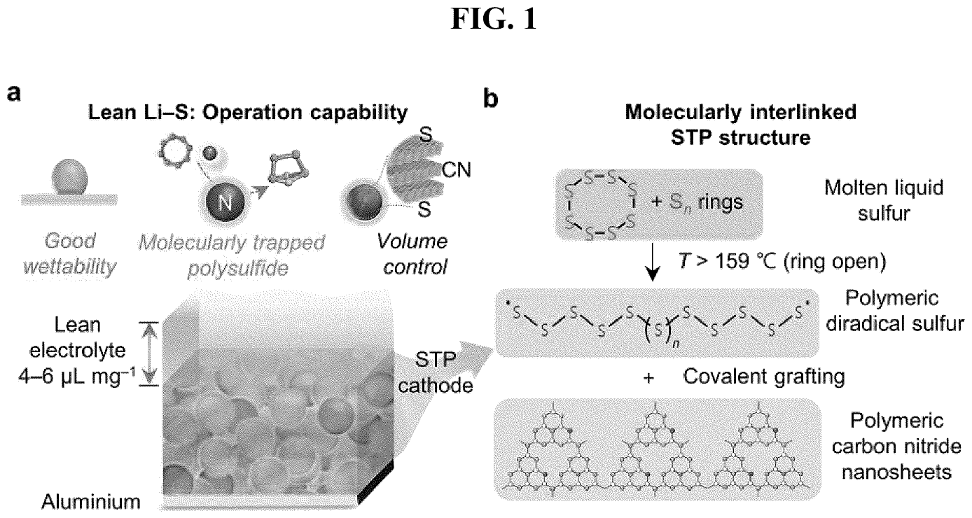

The covalently grafted sulfurized-triazine polymer (STP) cathode is prepared through thermal-assisted free-radical polymerization of diradical sulfur (S₈) and a tri-S-triazine (heptazine) framework as shown in Formula 2 above. The cyclic sulfur (S₈) rings may undergo ring-opening polymerization at 159 °C or higher in an inert gas atmosphere to form a chemically unstable linear polysulfane possessing diradical chain ends. As shown in FIG. 1(b), the formed diradical polysulfanes may be concurrently stabilized through inverse vulcanization with the unsaturated carbon-nitrogen double bonds of triazine (CxNy) to yield a covalently linked poly(sulfurized-triazine) structure. The resultant triazine polymer may covalently graft a large amount of sulfur through active C—S bonds, which is essential for high-energy density Li—S batteries.

### Lithium-Sulfur Battery Comprising Sulfurized-Triazine Polymer Cathode and Usable Under Lean Electrolyte Conditions

The present invention relates to a lithium-sulfur battery usable under lean electrolyte conditions comprising the sulfurized-triazine polymer cathode.

The sulfurized-triazine polymer of the present invention is a sulfurized-triazine polymer comprising: a triazine polymer and sulfur, wherein the sulfur is covalently grafted to the triazine polymer.

The present invention relates to a sulfurized-triazine polymer comprising: a triazine polymer and sulfur, wherein the sulfur is covalently grafted to the triazine polymer.

The triazine polymer may graft sulfur through C—S bonds to maintain a sulfur content of 60% or higher, and the grafted sulfur and sulfur rings (S) are highly reactive with Li ions, so that the reaction therebetween may easily occur.

The sulfurized-triazine polymer may have at least one structure selected from the group consisting of Formulas 2 to 7 below wherein sulfur is covalently bonded to a triazine polymer having a graphitic carbon nitride structure represented by Formula 1 below:

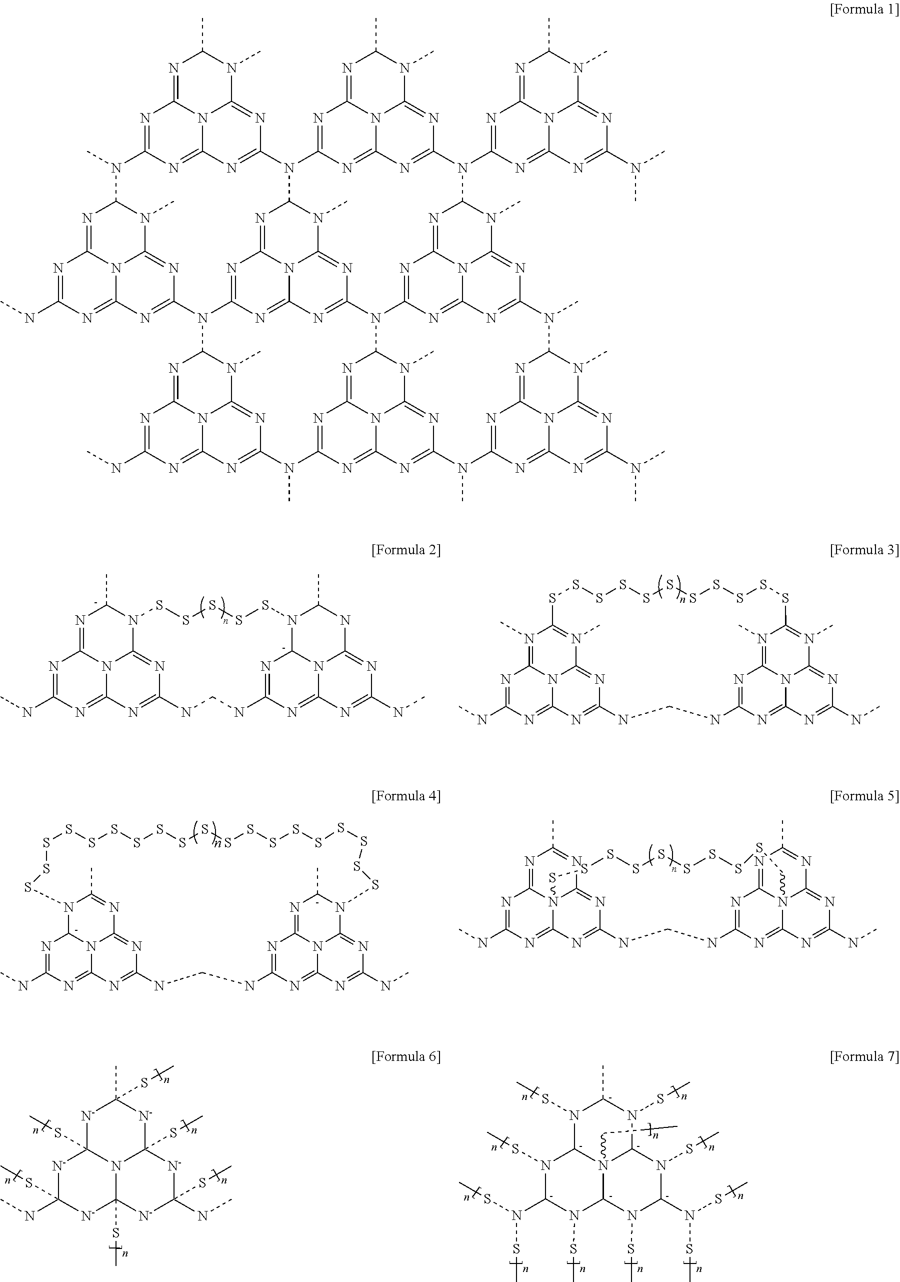

The covalently grafted sulfurized-triazine polymer (STP) cathode is prepared through thermal-assisted free-radical polymerization of diradical sulfur (S₈) and a tri-S-triazine (heptazine) framework as shown in Formula 2 above. The cyclic sulfur (S₈) rings may undergo ring-opening polymerization at 159 °C or higher in an inert gas atmosphere to form a chemically unstable linear polysulfane possessing diradical chain ends. As shown in FIG. 1(b), the formed diradical polysulfanes may be concurrently stabilized through inverse vulcanization with the unsaturated carbon-nitrogen double bonds of triazine (CxNy) to yield a covalently linked poly(sulfurized-triazine) structure. The resultant triazine polymer may covalently graft a large amount of sulfur through active C—S bonds, which is essential for high-energy density Li—S batteries.

The lithium-sulfur battery may exhibit sulfur reactivity under electrolyte conditions with a lean electrolyte/electrode ratio of 4 to 10 μL/mg.

Under electrolyte conditions with a lean electrolyte/electrode ratio of 4 to 10 μL/mg, the lithium-sulfur battery may realize an areal capacity approaching Li-ion battery (4 mAh/cm²), and impart multifunctional properties, such as good electrolyte wettability, molecularly trapped polysulfides, and volume control, as shown in FIG. 1(a).

Li₂S₄ generated during charge and discharge of the lithium-sulfur battery may be subjected to bulk-immobilization by interaction with at least one selected from the group consisting of pyridinic-N and pyrrolic-N.

The triazine framework forming the sulfurized-triazine polymer of the lithium-sulfur battery allows the nitrogen species to remain in multiple coordination states, such as pyridinic, pyrrolic, and graphitic nitrogens. Such abundant nitrogens maintained in this manner may combine with multiple polysulfides.

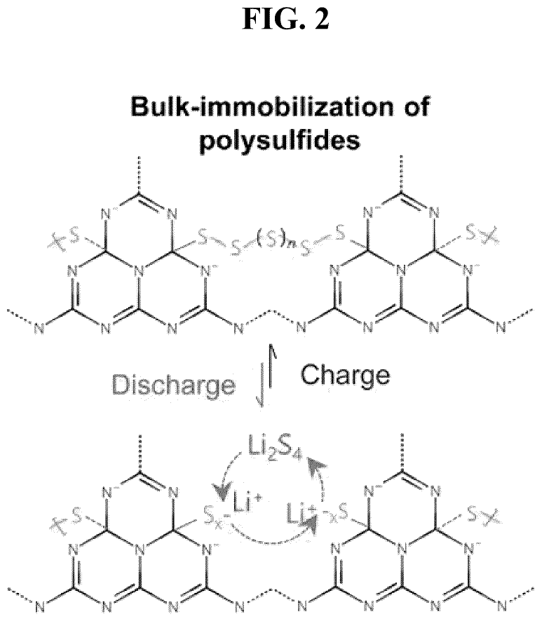

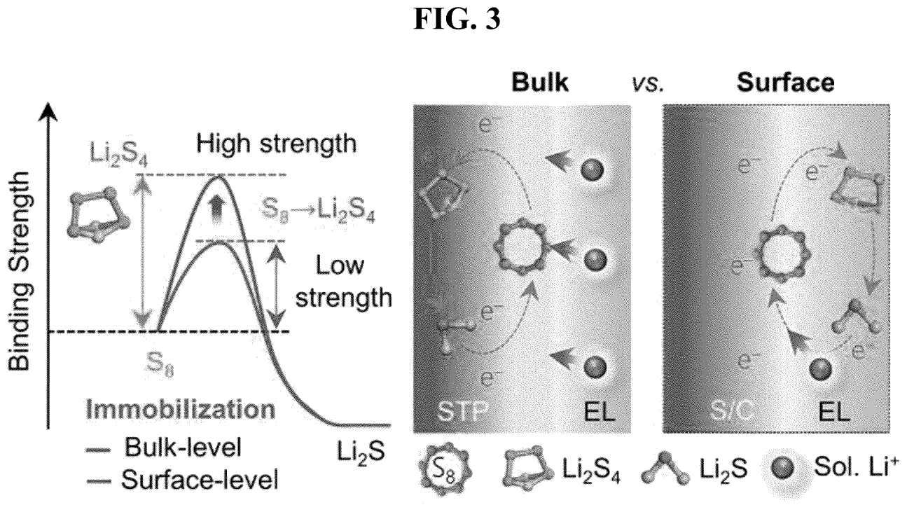

As shown in FIG. 2, during charge/discharge of the lithium-sulfur battery, Li ions interact with Se rings to form Li₂S₄, a higher-order polysulfide. The produced Li₂S₄ is immobilized through strong interaction imparted by pyridinic-N and pyrrolic-N, and in particular, the polysulfide capture may occur at close proximity to the reaction site to effectively trap them in a molecularly fashion while leaving no time for its dissolution in liquid electrolyte. In this case, the immobilization is bulk-immobilization rather than surface immobilization as shown in FIG. 3, and confining polysulfides through bulk immobilization occurs due to the high binding strength offered by the triazine toward polysulfides.

The lithium-sulfur battery may exhibit a capacity of 500 to 650 mAh/g at the 150^{th} to 200^{th} cycles.

The lithium-sulfur battery may exhibit a Coulombic efficiency of 85 to 98% at an electrolyte/electrode ratio of 4 to 10 μL/mg when a sulfur loading amount of 3 to 7 mg/cm² is applied.

The lithium-sulfur battery may exhibit a capacity of 500 to 650 mAh/g at an electrolyte/electrode ratio of 4 to 10 μL/mg when a sulfur loading amount of 3 to 7 mg/cm² is applied.

The lithium-sulfur battery may be used as a pouch cell, and it exhibits an energy density of 300 to 400 Wh/kg when used as the pouch cell.

In the present invention, the lithium-sulfur battery may be used as a flexible cell.

### EXAMPLES

Hereinafter, examples of the present invention will be described in detail, but it is obvious that the present invention is not limited by the following examples.

The advantages and features of the present invention, and the way of attaining them, will become apparent with reference to the embodiments below described in detail. However, the present invention is not limited to the embodiments disclosed below and may be embodied in a variety of different forms. Rather, these embodiments are provided so that this disclosure will be thorough and complete and will fully convey the scope of the present invention to those skilled in the art. The present invention will be defined only by the scope of the claims.

### Example 1. Sulfurized-Triazine Polymer (STP)

Triazine powder was prepared using a thermal condensation reaction of melamine powder. Specifically, 1 g of melamine was placed in an alumina boat and transferred to an atmosphere-controlled tubular furnace with the lid closed. Then, the heating chamber was purged with nitrogen (100 mL/min) for about 30 minutes. Then, the thermal condensation of melamine was initiated at 3 °C per minute to 550 °C for 4 hours. After the condensation had been completed, the product was naturally cooled, followed by grinding and stored.

Then, about 100 mg of triazine was dispersed in 5 mL of preheated H₂SO₄ for about 6 hours. Thereafter, an equal volume of de-ionized water was added to the triazine-acid mixture, the reaction temperature was increased, and then the reaction mixture was stirred for another 10 hours. At the end of the acid treatment, the reaction mixture changed from pale yellow to whitish, indicating successful exfoliation of triazine nanosheets. The mixture was neutralized with de-ionized water until the pH reached 7. The solution resulting from the neutralization was centrifuged at 6,000 RPM and then dried at 60 °C to obtain nanosheet powder.

Thereafter, the preparation of sulfurized-triazine followed a ring-opening polymerization reaction at 160 °C or higher.

First, a sulfur/carbon composite was prepared through a melt infiltration process performed in a nitrogen atmosphere (100 mL/min) at 155 °C for 12 hours at a heating rate of 3 °C per minute. Then, about 3 wt % of the obtained triazine nanosheets were mixed with the sulfur/carbon composite for about 1 hour and then subjected to a ring-opening polymerization at 160 °C in a nitrogen atmosphere for 10 hours at 5 °C per minute. During the heat treatment process, the sulfur (S) rings opened above 159° Cor higher to form linear polysulfides possessing chain ends. The polysulfides were covalently grafted with the carbon adjacent to the nitrogen of triazine rings to produce a sulfurized-triazine polymer.

### Example 2. Sulfurized-Triazine Polymer Electrode (STP Electrode)

The sulfurized-triazine polymer (STP) produced according to Example 1 was prepared according to a doctor blade method. Electrode constituents comprised the STP as an active material, multi-walled carbon nanotubes (MWCNTs) as a conductive agent, and polyvinylidene difluoride (PVDF) as a binder at a weight ratio of 8:1.5:0.5. The constituents were thoroughly intermixed for about 45 minutes, and then N-methyl pyrrolidone as a solvent was added to the mixture to form a viscous slurry. Then, the obtained slurry was cast over a precleaned battery-grade aluminum foil (17 μm thickness), dried overnight at room temperature for 12 hours or more, and vacuum-dried at 80 °C for 12 hours. The dried sulfur electrodes were punched to obtain sulfur electrodes.

### Example 3. Lean Li—S Pouch Cell

A lean Li—S pouch battery was fabricated using the STP electrode as a working electrode (2 cm×3 cm sulfurized-triazine electrode), polypropylene as a separator, and polished thin lithium metal (2 cm×3 cm) as a reference electrode. The STP and lithium metal electrodes were externally connected using aluminum tabs and encased with an aluminum laminated film. Then, the side leading the tabs was sealed using a hot press, and upon ensuring proper stacking and external contact, the other sides were sealed in the same manner. Prior to final sealing, a small amount of liquid electrolyte calculated based on the E/S ratio was infiltrated. The electrolyte used was 1M LiTFSI prepared in (1:1 v/v) DOL:DME solvent with 2% LiNO₃ as an additive.

### Comparative Example 1. S—C Electrode

An electrode was fabricated in the same manner as in Example 2, except S—C bare was used instead of STP as the active material.

### Experimental Example 1. Experiments on Sulfur-Triazine Covalent Bonds Using FT-IR and Raman Spectroscopy

To confirm the C—S covalent bonds of the sulfurized-triazine polymer, FT-IR and Raman spectroscopy experiments were conducted using the sulfurized-triazine polymer produced in Example 2 and the S/C electrode fabricated in Comparative Example 1.

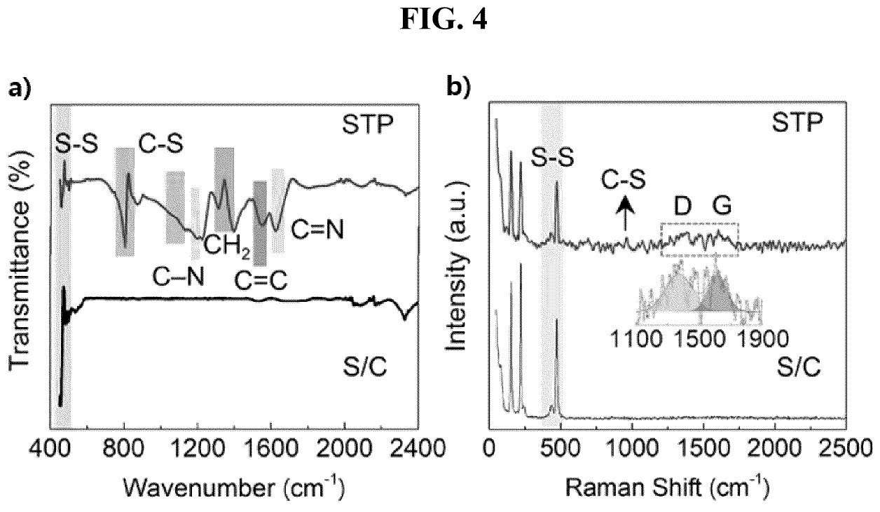

The FT-IR experiment was conducted using UATR2 (Perkin Elmer) in a spectral range of 4,000 to 500 cm-1, and the results are shown in FIG. 4(a).

The Raman spectroscopy experiment was conducted using LabRAM HR800 (Horiba) at a laser wavelength of 532 nm, and the results are shown in FIG. 4(b).

As shown in FIG. 4(a), the spectra resulting from the FT-IR experiment validated the formation of C—S bonds in the electrode, including the sulfurized-triazine polymer through a sharp band exhibited by sulfurized-triazine at 778 cm-1 and a broad band at 1,150 cm−1 in the electrode including the sulfurized-triazine polymer (STP) of Example 2. However, in the S/C electrode of Comparative Example 1, sulfur was not bonded to triazine, and thus C—S covalent bonds were not confirmed.

In addition, as shown in FIG. 4(b), the electrode including the sulfurized-triazine polymer (STP) of Example 2, exhibited a characteristic Raman band at 962 cm−1 corresponding to covalent C—S stretching vibrations, indicating sulfur-carbon (C—S) covalent bonds. However, the S/C electrode of Comparative Example 1 showed characteristic Raman bands at 472 and 433 cm−1, indicating the S—S bond, but C—S covalent bonding was not confirmed because sulfur was not bonded to triazine.

From the results shown in the Raman experiment and the FT-IR experiment, it can be confirmed that the C—S covalent bonds, including the sulfurized-triazine polymer (STP), were successfully formed in the electrode.

### Experimental Example 2. Test for Electrochemical Performance of Lithium-Sulfur Battery Including Sulfurized-Triazine Polymer Electrode Under Lean Electrolyte

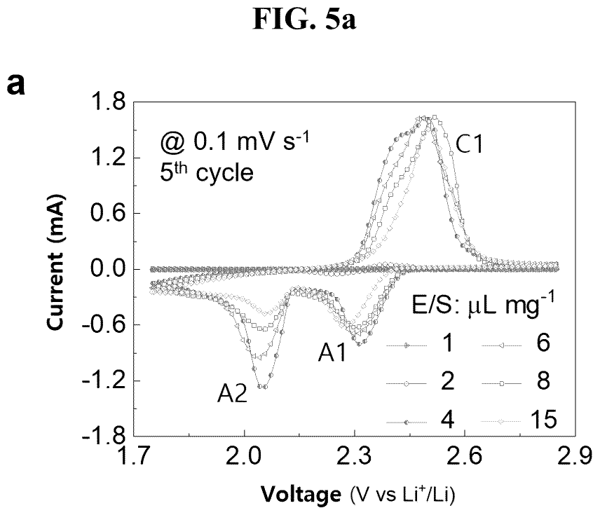

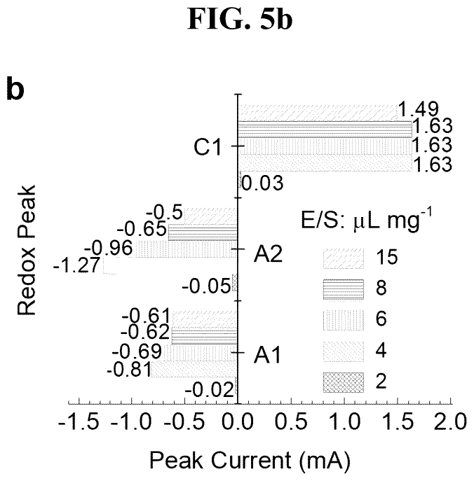

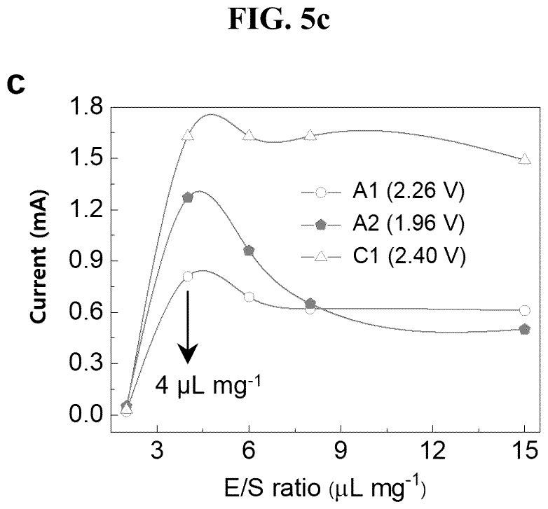

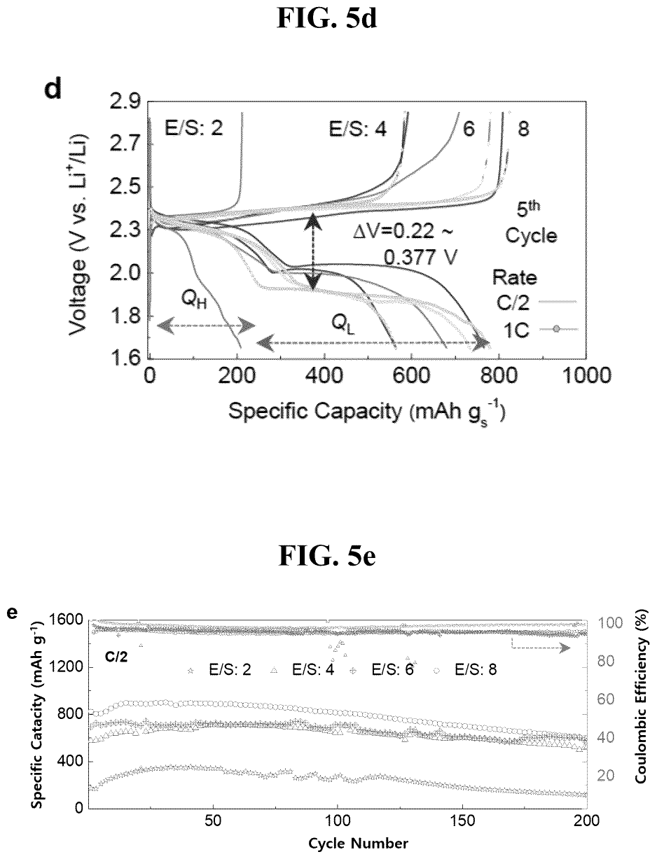

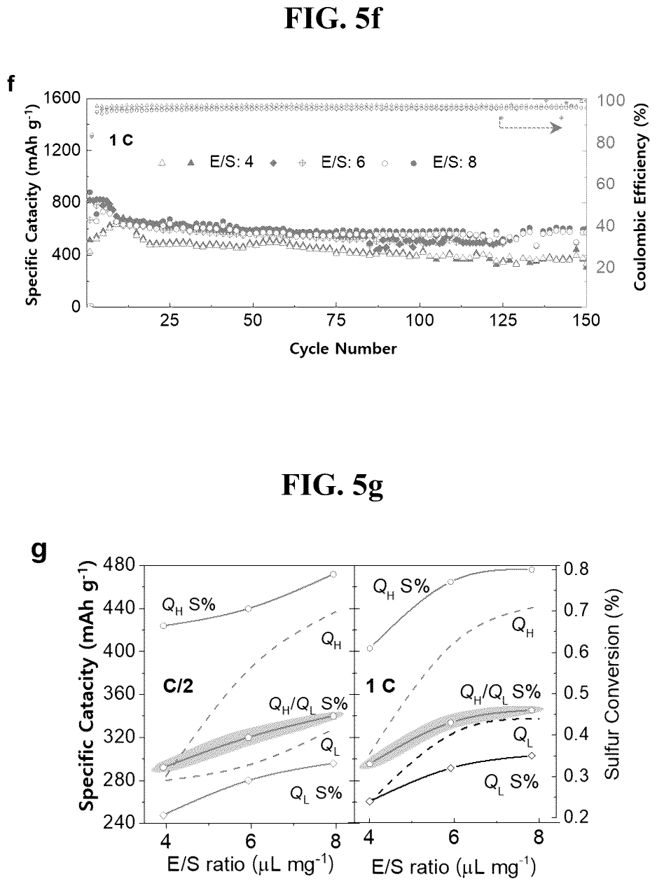

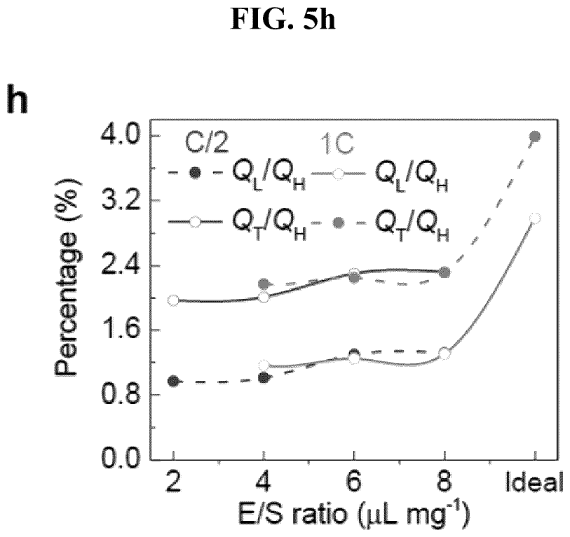

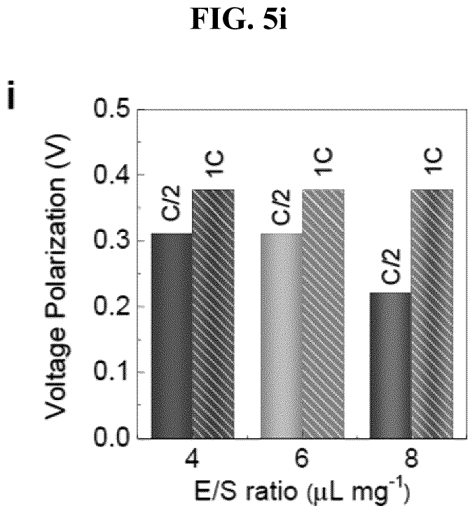

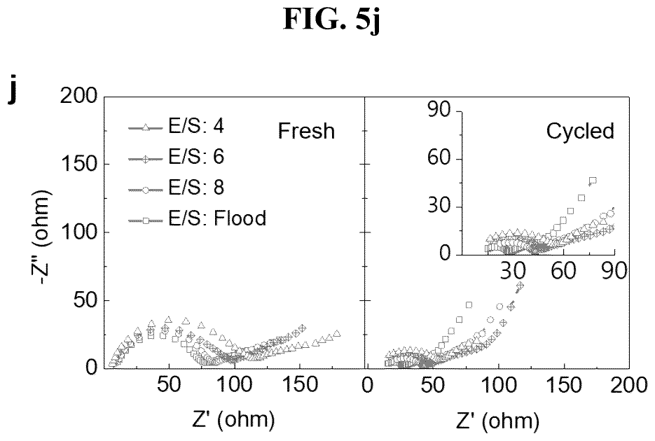

The electrochemical performances of the sulfurized-triazine polymer (STP) electrodes fabricated in Examples 1 and 2 and the S/C electrode fabricated in Comparative Example 1 were tested by performing cyclic voltammetry in a potential window of 1.7 to 2.8 V at a scan rate of 0.1 mV/s under lean electrolytes having electrolyte/sulfur (E/S) ratios of 2, 4, 6, and 8 μL/mg and under flooded electrolyte having an E/S ratio of 15 μL/mg, and the results are shown in FIG. 5.

As shown in FIGS. 5(a) and 5(b), the STP electrodes of Examples 1 and 2 exhibited sulfur reduction peaks at 2.25 (A1) and 2.0 V (A2) and oxidation peaks at 2.45 V (C1). However, when the E/S ratio decreased below 2 μL/mg, the STP electrodes remained inaccessible to the Li ions to trigger sulfur reactivity. Such a case was also observed even at a high E/S ratio of 10 μL/mg or higher.

In addition, as shown in FIG. 5(c), the STP electrodes according to Examples 1 and 2 exhibited better peak currents than the S/C electrode according to Comparative Example 1 due to the precise control of Li₂S₄ and Li₂S through molecular adsorption by triazine at various E/S ratios. In particular, the peak currents at A1 (S₈→Li₂S₄) remained similar for Li—S cells at all E/S ratios, whereas the peak currents at A2 (Li₂S₄→Li₂S) showed various peak currents because the exact peak current in each solvent was determined by the chemical reaction in each solvent. This is evidenced by more diverse peaks at C1 (Li₂S→S⁸), where the peak shape evolves and spreads as the E/S ratio approaches 4 μL/mg from 8 μL/mg.

From the above results, it can be seen that the STP electrodes exhibit better sulfur kinetics than the S/C electrode under lean electrolyte conditions.

In addition, as shown in FIGS. 5(d) to 5(g), the performance of the STP electrode was investigated at 1C (1.675 A/gₛ), and the discharge capacity at the end of the 5^{th} cycle stood at 592, 708, and 809 mAh/g under lean electrolyte conditions with E/S ratios of 4, 6, and 8 μL/mg, while the capacity differences are within 101 to 217 mAh/g, indicating low voltage polarization, confirming that the STP cathodes satisfy the capacity and polarization criteria required for operating Li—S cells.

In addition, as shown in FIGS. 5(h) to 5(j), the cycle characteristics of the STP electrode showed 576, 697, and 826 mAh/g at C/2 and 406, 495, and 502 mAh/g at 1 C at E/S ratios of 4, 6, and 8 μL/mg, and the Coulombic efficiencies were 96, 98.5, and 96%, respectively, indicating excellent life characteristics. Further, upon repetitive discharge/charge, the STP electrodes exhibited a stable capacity until the 200^{th} cycle with a low-capacity decay per cycle at 0.11 to 0.02. In particular, the STP electrodes at an E/S ratio of 4 to 6 μL/mg showed capacities of 522 and 574 mAh/g from the 34^{th} cycle and kept cycling with minimal decay until the 200^{th} cycle.

From the above results, it can be confirmed that the sulfurized-triazine polymer cathode of the present invention satisfies the capacity and polarization criteria required for operating a lithium-sulfur cell under lean electrolyte conditions.

### Experimental Example 3. Density Functional Theory (DFT) Analysis of Sulfurized-Triazine Polymer Electrodes

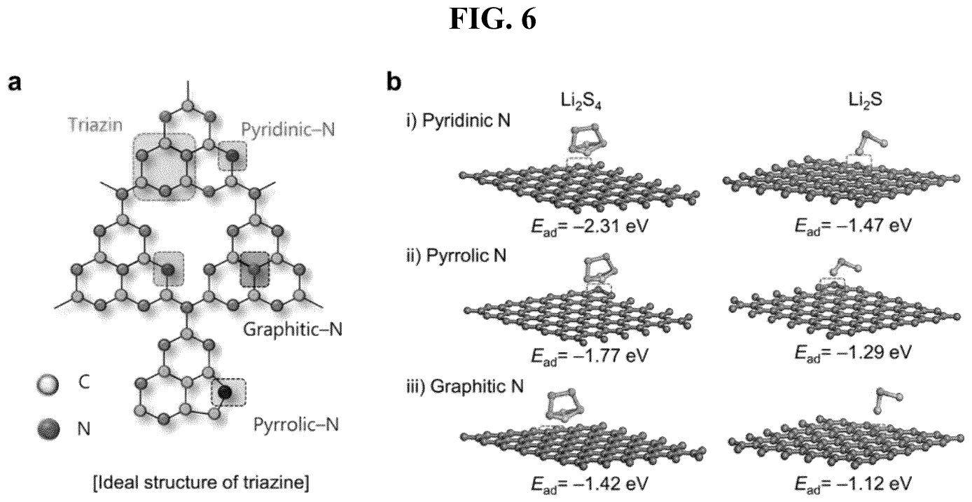

Density functional theory (DFT) analysis of the sulfurized-triazine polymer electrodes fabricated according to Examples 1 and 2 was performed to understand the possible interaction of polysulfides with nitrogen gas, and the results are shown in FIG. 6.

The absorption energy of polysulfides in triazine of the sulfurized-triazine polymer electrode is calculated by Equation 1 below.

E_{ads}=Eₜₒₜₐₗ−(E_{g}+Eₚₛ) [Equation 1]

As shown in FIG. 6, the HOPS and LOPS of pyridinic-N are E_{ads}=−2.31 and −1.47 eV, respectively, and the HOPS and LOPS of pyrrolic-N are E_{ads}=−1.77 and −1.29 eV, respectively, and the HOPS and LOPS of graphitic-N are E_{ads}=−1.42 and −1.12 eV, respectively.

From the above results, it can be confirmed that pyridinic-N has higher adsorption energy for polysulfides than pyrrolic-N and graphitic-N structures, and that the sulfurized-triazine polymer electrode including the same has improved electrochemical performance under lean electrolyte conditions.

### Experimental Example 4. Test for Performance of Pouch-Type Lean Lithium-Sulfur Battery

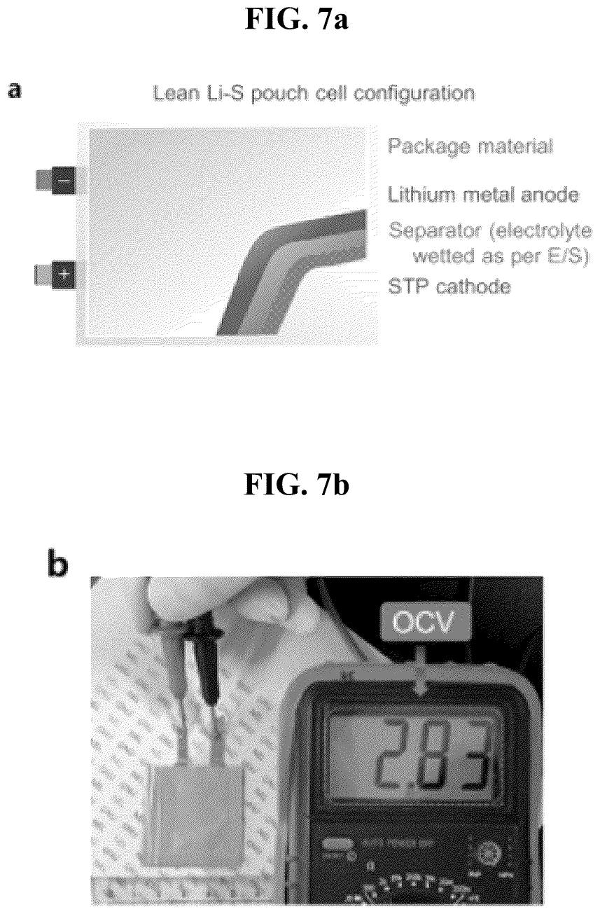

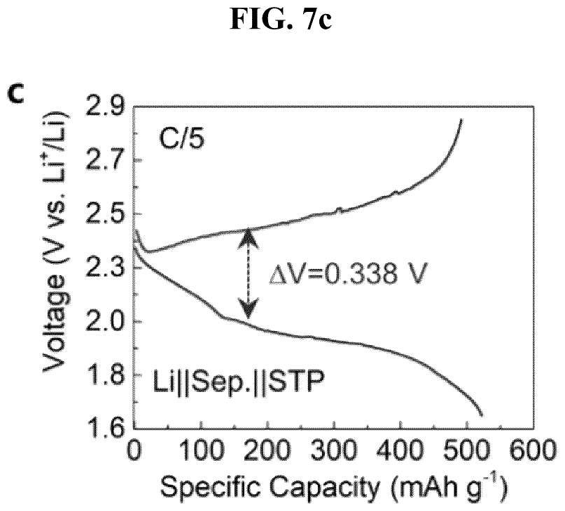

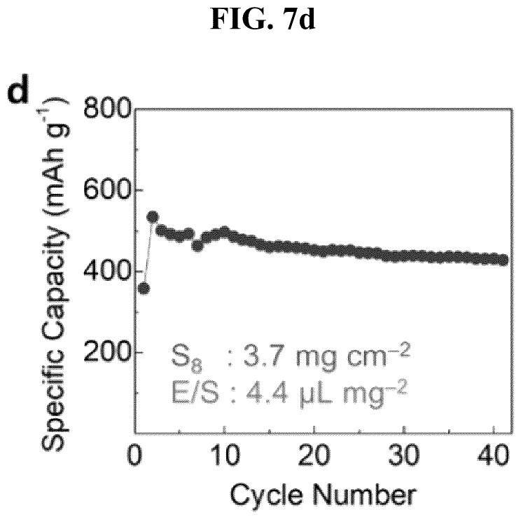

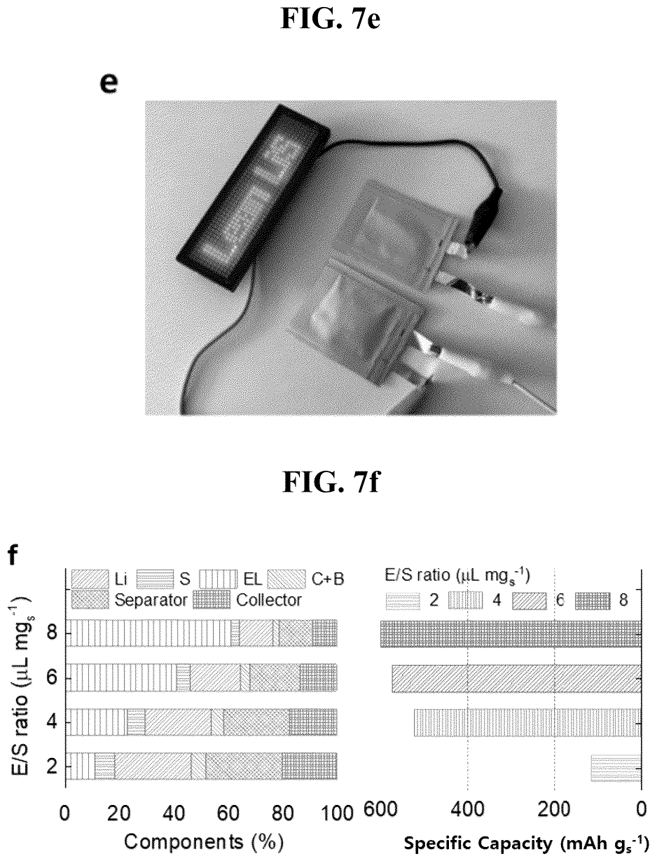

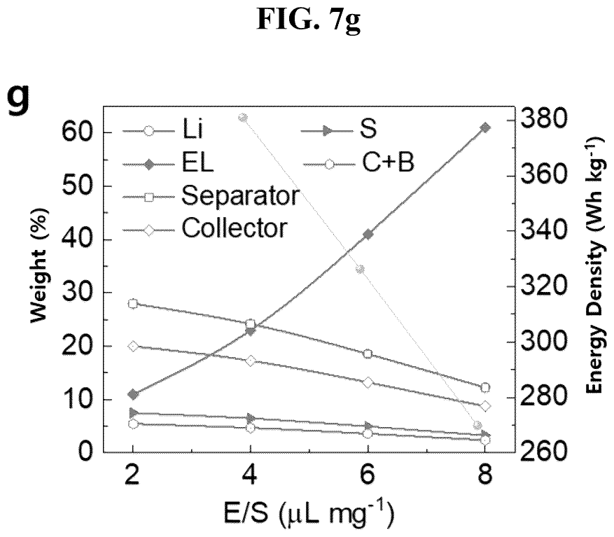

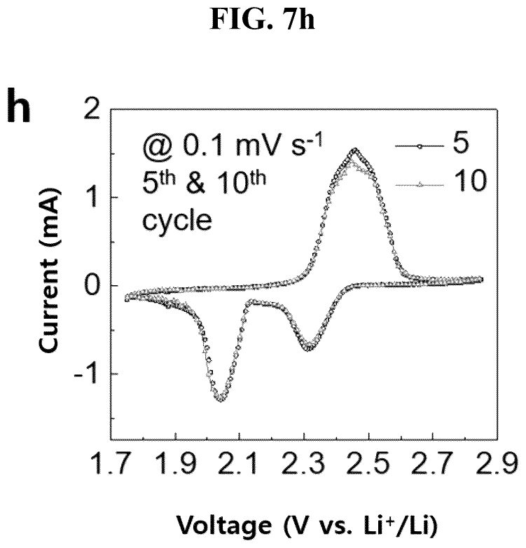

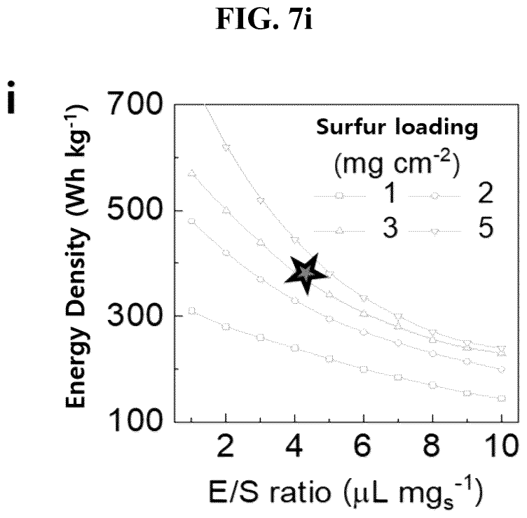

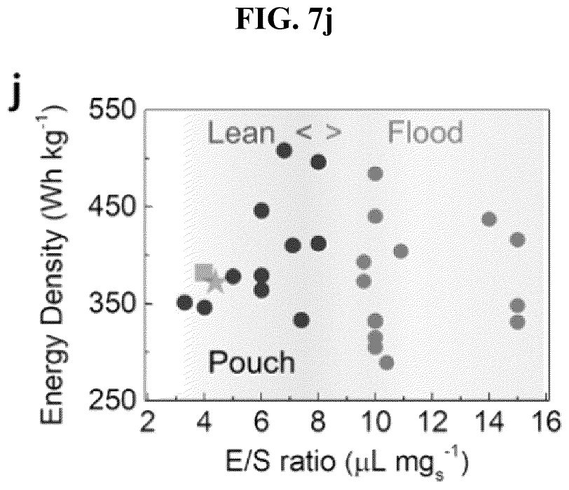

To investigate the electrochemical performance of the lean Li—S pouch cells including the sulfurized-triazine polymer electrodes fabricated according to Examples 1 to 3 under lean electrolyte conditions, experiments were conducted using a 2 cm×3 cm pouch-type lithium-sulfur (Li—S) battery fabricated according to Example 3, and the results are shown in FIG. 7.

As shown in FIG. 7(b), the Li—S pouch battery showed an OCV of 2.83 V, as shown in FIG. 7(c), the galvanostatic discharge/charge profile for the un-pressured Li—S pouch exhibited a voltage polarization of 0.388 V at a C/5 rate

In addition, as shown in FIG. 7(d), the pouch Li—S battery exhibited demonstrated good cycling stability and 524 mAh/g with a Coulombic efficiency of 98%. Moreover, the capacity retention was stably maintained until the end of the 40^{th} cycle.

In addition, as shown in FIG. 7(e), the Li—S battery was capable of glowing a light-emitting diode with a threshold of 5.3 V.

In addition, as shown in FIGS. 7(h) to 7(j), the Li—S battery exhibited an excellent energy density of 371 Wh/kg at an E/S ratio of 6 μL/mg, and an energy density higher than the theoretical value at 4.4 μL/mg.

From the above-described results, it can be confirmed that the sulfurized-triazine electrode according to the present invention exhibits excellent electrochemical performance under lean electrolyte conditions, has a stable capacity with high energy density, excellent cycle life, polysulfide immobilization, and self-discharge prevention properties, and can satisfy the necessary conditions of a lithium-sulfur battery requiring high energy density.

1. A sulfurized-triazine polymer comprising: a triazine polymer and sulfur, wherein the sulfur is covalently grafted to the triazine polymer.

2. The sulfurized-triazine polymer of claim 1, wherein the sulfurized-triazine polymer has at least one structure selected from the group consisting of Formulas 2 to 7 below, wherein sulfur is covalently bonded to a triazine polymer having a graphitic carbon nitride structure represented by Formula 1 below:

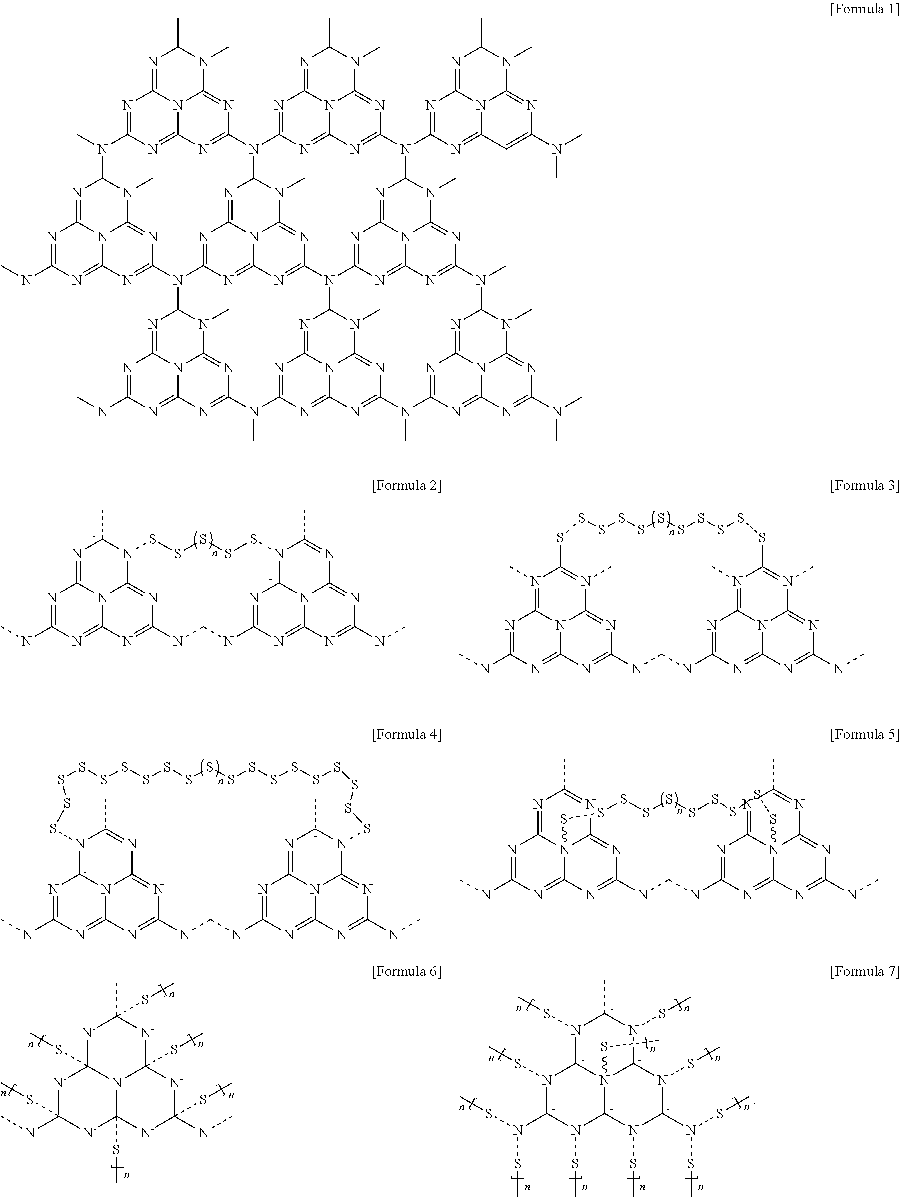

3. A lithium-sulfur battery usable under lean electrolyte conditions, comprising the sulfurized-triazine polymer of claim 1 as a cathode.

4. The lithium-sulfur battery of claim 3, wherein the lithium-sulfur battery exhibits sulfur reactivity under electrolyte conditions with a lean electrolyte/electrode ratio of 4 to 10 μL/mg.

5. The lithium-sulfur battery of claim 3, wherein Li₂S₄ generated during charge and discharge of the lithium-sulfur battery is subjected to bulk-immobilization by interaction with at least one selected from the group consisting of pyridinic-N and pyrrolic-N.

6. The lithium-sulfur battery of claim 3, wherein the lithium-sulfur battery exhibits an electric capacity of 500 to 650 mAh/g at the 150^{th} to 200^{th} cycles.

7. The lithium-sulfur battery of claim 3, wherein the lithium-sulfur battery exhibits a Coulombic efficiency of 85 to 98% at an electrolyte/electrode ratio of 4 to 10 μL/mg when a sulfur loading amount of 3 to 7 mg/cm² is applied.

8. The lithium-sulfur battery of claim 3, wherein the lithium-sulfur battery exhibits a capacity of 500 to 650 mAh/g at an electrolyte/electrode ratio of 4 to 10 μL/mg when a sulfur loading amount of 3 to 7 mg/cm² is applied.

9. The lithium-sulfur battery of claim 3, wherein the lithium-sulfur battery is usable as a pouch cell, and exhibits an energy density of 300 to 400 Wh/kg when used as the pouch cell.

10. The lithium-sulfur battery of claim 3, wherein the lithium-sulfur battery is usable as a flexible cell.
